(19) United States
(12) Patent Application Publication
(10) Pub. No.: US 2023/0386437 A1
(43) Pub. Date: Nov. 30, 2023

(54) NEURAL NETWORK MODEL FOR AUDIO TRACK LABEL GENERATION

(71) Applicant: Lemon Inc., Grand Cayman (KY)

(72) Inventors: Ju-Chiang Wang, Los Angeles, CA (US); Yun-Ning Hung, Culver City, CA (US); Jordan Smith, London (GB)

(21) Appl. No.: 17/804,198

(22) Filed: May 26, 2022

(51) Int. Cl. G10H 1/00; G06N 3/08

(52) U.S. Cl. CPC G10H 1/0008; G06N 3/08; G10H 2210/056

(57) ABSTRACT

System and methods directed to identifying music theory labels for audio tracks are described. More specifically, a first training set of audio portions may be generated from a plurality of audio tracks, segments within the plurality of audio tracks being labeled according to a plurality of music theory labels. A deep neural network model may then be trained using the first training set as an input, a first loss function for music theory label identifications of audio portions of the first training set, and a second loss function for segment boundary identifications within the audio portions of the first training set. In examples, the music theory label identifications and the segment boundary identifications are generated by the deep neural network model. A first audio track is received and segment boundary identifications and music theory labels for segments within the first audio track are generated using the deep neural network model.

### BACKGROUND

Popular songs may be organized into common music structural elements according to music theory. Some music structural elements may appear only once, such as a particular verse or solo within a song, while other elements may be repeated two or more times, such as a chorus or bridge. In some scenarios, identifying these music structural elements within a song facilitates extracting an audio “thumbnail” or preview of a song, because more familiar elements (e.g., a chorus) can be more readily extracted for the thumbnail, instead of simply taking random excerpts from the song. In other scenarios, a user may wish to create a remix or mashup of several songs, which is made easier by having labeled structural elements so that particular sections of a song with a common theme may be copied together or placed in a musically pleasing order. However, several users may have different subjective opinions on when a music structural element has begun or which music structural element is present. The subjective nature of the timing and selection of the music structural elements creates challenges for computing devices to automatically identify the music structural elements for new songs or audio tracks.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to neural network models for identifying music theory labels for audio tracks.

In one aspect, a computer-implemented method of training a neural network model for identifying music theory labels for audio tracks is provided. A first training set of audio portions is generated from a plurality of audio tracks. The segments within the plurality of audio tracks may be labeled according to a plurality of music theory labels. A deep neural network model is trained using the first training set as an input, a first loss function for music theory label identifications of audio portions of the first training set, and a second loss function for segment boundary identifications within the audio portions of the first training set. The music theory label identifications and the segment boundary identifications are generated by the deep neural network model. A first audio track is received. Segment boundary identifications are generated for segments within the first audio track using the deep neural network model. Music theory labels for the segments within the first audio track are generated using the deep neural network model.

In another aspect, a method for identifying music theory labels for an audio track is provided. An audio track is received. The audio track is divided into a first set of audio portions. Music theory label identifications and segment boundary identifications are generated using a deep neural network model for the first set of audio portions. The generated music theory label identifications for the first set of audio portions are merged and the segment boundary identifications for the first set of audio portions are merged. Segments within the audio track are identified using the merged segment boundary identifications. Respective music theory labels are identified for the identified segments.

In yet another aspect, a non-transient computer-readable storage medium comprising instructions being executable by one or more processors, that when executed by the one or more processors, cause the one or more processors to: generate a first training set of audio portions from a plurality of audio tracks, wherein segments within the plurality of audio tracks are labeled according to a plurality of music theory labels; train a deep neural network model using the first training set as an input, a first loss function for music theory label identifications of audio portions of the first training set, and a second loss function for segment boundary identifications within the audio portions of the first training set, wherein the music theory label identifications and the segment boundary identifications are generated by the SpecTNT neural network model; receive a first audio track; generate segment boundary identifications for segments within the first audio track using the deep neural network model; and generate music theory labels for the segments within the first audio track using the deep neural network model.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS/FIGURES

Non-limiting and non-exhaustive examples are described with reference to the following Figures.

FIG. 1 shows a block diagram of an example of a system for training a neural network model for identifying music theory labels for audio tracks, according to an example embodiment.

FIG. 2 shows a block diagram of an example of a neural network model for providing segment boundary identifications and music theory label identifications, according to an example embodiment.

FIG. 3 shows a diagram of an example neural network model for providing segment boundary identifications and music theory label identifications, according to an example embodiment.

FIG. 4 shows a diagram of an example logic flow for providing segment boundary identifications and music theory label identifications, according to an example embodiment.

FIG. 5 shows a diagram of an example plurality of label probability curves, according to an example embodiment.

FIG. 6 shows a diagram of an example plurality of label probability curves, boundary probability curve, and post-processed music theory label identifications, according to an example embodiment.

FIG. 7A shows a flowchart of an example method of training a neural network model for identifying music theory labels for audio tracks, according to an example embodiment.

FIG. 7B shows a flowchart of an example method of identifying music theory labels for an audio track, according to an example embodiment.

FIG. 8 is a block diagram illustrating example physical components of a computing device with which aspects of the disclosure may be practiced.

FIGS. 9 and 10 are simplified block diagrams of a mobile computing device with which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure describes various examples of a computing device having an audio processor configured to train a neural network model for identifying music theory labels for audio tracks. Non-overlapping segments within the audio tracks are labeled beforehand with suitable music theory labels. In some examples, the music theory labels correspond to music theory structures, such as introduction (“intro”), verse, chorus, bridge, outro, or other suitable labels. In other examples, the music theory labels correspond to non-structural music theory elements, such as vibrato, harmonics, chords, etc. In still other examples, the music theory labels correspond to key signature changes, tempo changes, etc. In some examples, the audio processor identifies music theory labels for segments that overlap, such as labels for key signatures, tempo changes, and structures (i.e., intro, verse, chorus).

In some examples, the audio processor divides the audio tracks into portions of fixed duration, such as 15 seconds, 24 seconds, 60 seconds, or another suitable duration. The neural network model is then trained using the portions as inputs, a first loss function for music theory label identifications of audio portions, and a second loss function for segment boundary identifications within the audio portions. The music theory label identifications and segment boundary identifications are generated by the SpecTNT neural network model, with the music theory label identification identifying estimated music theory labels (e.g., verse, chorus) for segments between the identified segment boundaries. Once trained, the neural network model may be used to identify music theory labels for audio tracks, even when those audio tracks have a duration that is shorter than a typical audio track (e.g., 20 seconds vs. 3 or more minutes). In some scenarios, the neural network model labels segments within audio tracks or audio portions for automatic preview extraction of a song. For example, identified chorus sections of a song may be used for generating a preview because the chorus is generally considered to be the ‘most prominent’ and ‘most catchy’ section of a song.

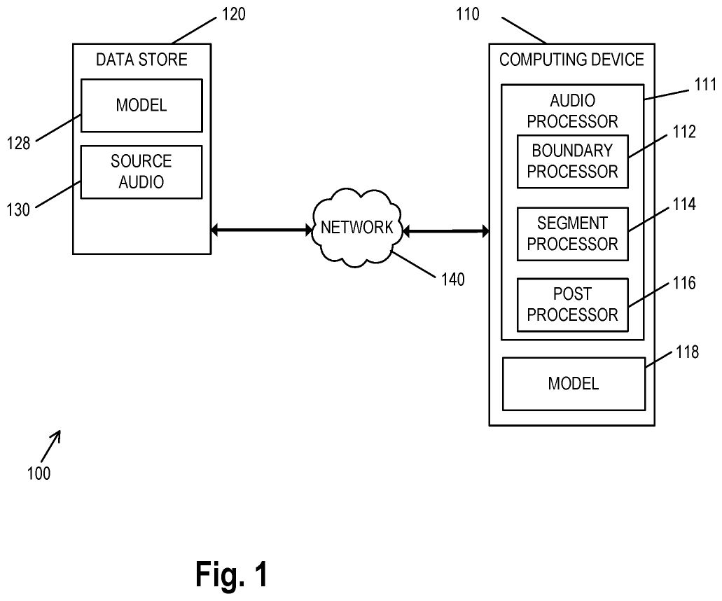

This and many further embodiments for a computing device are described herein. For instance, FIG. 1 shows a block diagram of an example of a system 100 for training a neural network model for identifying music theory labels for audio tracks, according to an example embodiment. The system 100 includes a computing device 110 that is configured to train a neural network model, such as a neural network model 118 and/or neural network model 128. In some examples, the computing device 110 is configured to perform music structure analysis for audio tracks or audio portions. The system 100 may also include a data store 120 that is communicatively coupled with the computing device 110 via a network 140, in some examples.

The computing device 110 may be any type of computing device, including a smartphone, mobile computer or mobile computing device (e.g., a Microsoft® Surface® device, a laptop computer, a notebook computer, a tablet computer such as an Apple iPad™ a netbook, etc.), or a stationary computing device such as a desktop computer or PC (personal computer). The computing device 110 may be configured to communicate with a social media platform, cloud processing provider, software as a service provider, or other suitable entity, for example, using social media software and a suitable communication network. The computing device 110 may be configured to execute one or more software applications (or “applications”) and/or services and/or manage hardware resources (e.g., processors, memory, etc.), which may be utilized by users of the computing device 110.

Computing device 110 comprises an audio processor 111 and the neural network model 118. In the example shown in FIG. 1, the audio processor 111 includes a boundary processor 112, a segment processor 114, and a post processor 116. In other examples, one or more of the boundary processor 112, the segment processor 114, and the post processor 116 may be formed as a combined processor. In some examples, at least some portions of the audio processor 111 may be combined with the neural network model 118, for example, by including a neural network processor or other suitable processor configured to implement a neural network model. In other words, the neural network model 118 may be integral with the audio processor 111 and implemented with, or as, a neural network processor. In some examples, the neural network model 118 is omitted from the computing device 110 and the neural network model 128 is utilized instead.

The boundary processor 112 is configured to generate segment boundary identifications within audio portions. For example, the boundary processor 112 may receive audio portions and identify boundaries within the audio portions that correspond to changes in a music theory label. Generally, the boundaries identify non-overlapping segments within a song or excerpt having a particular music theory label. As an example, an audio portion with a duration of 24 seconds may begin with a four second intro, followed by an 8 second verse, then a 10 second chorus, and a two second verse (e.g., a first part of a verse). In this example, the boundary processor 112 may generate segment boundary identifications at 4 seconds, 12 seconds, and 22 seconds. In some examples, the boundary processor 112 communicates with the neural network model 118 and/or the neural network model 128 to identify the boundaries.

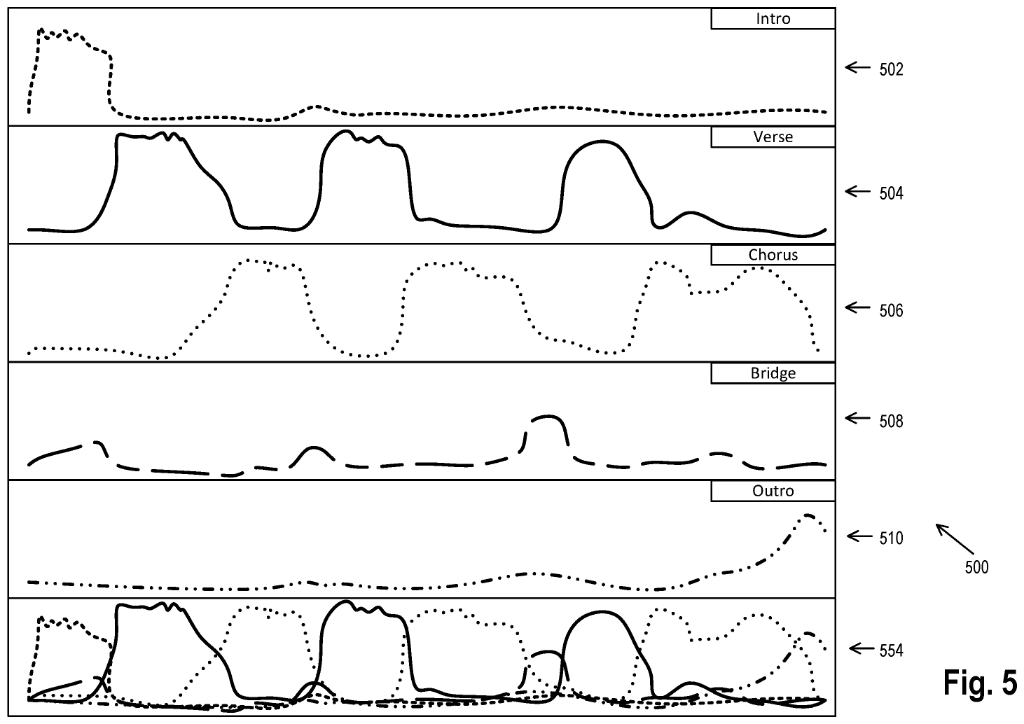

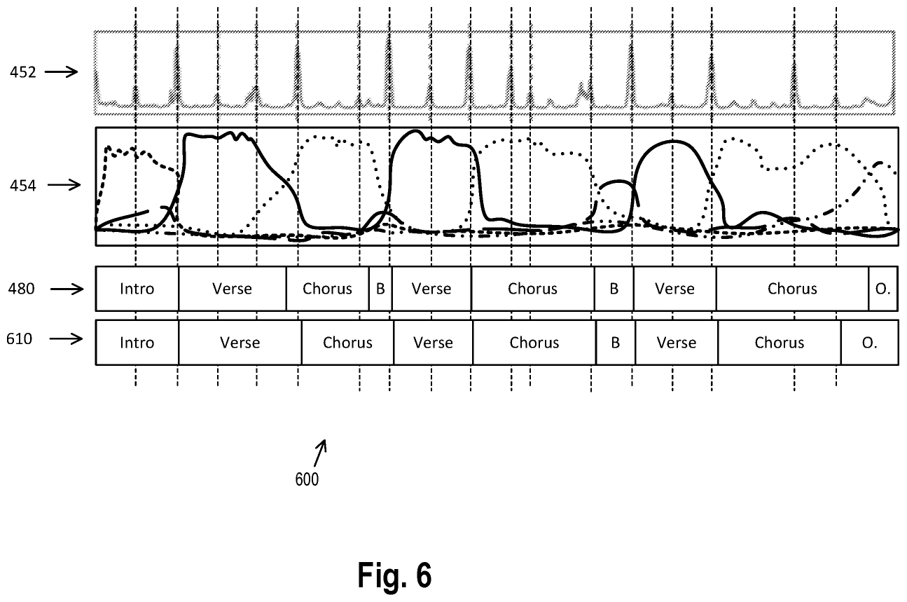

The segment processor 114 is configured to generate music theory label identifications for audio portions. In various examples, the music theory label identifications may be selected from a plurality of music theory labels. In some examples, at least some of the plurality of music theory labels denote a structural element of music. Examples of music theory labels may include introduction (“intro”), verse, chorus, bridge, instrumental (e.g., guitar solo or bass solo), outro, silence, or other suitable labels. In some examples, the segment processor 114 identifies a probability that a particular audio portion, or a section or timestamp within the particular audio portion, corresponds to a particular music theory label from the plurality of music theory labels. In other examples, the segment processor 114 identifies a most likely music theory label for the particular audio portion (or the section or timestamp within the particular audio portion). In still other examples, the segment processor 114 identifies start and stop times within the audio portion for when the music theory labels are active. Further details of the music theory label identifications are provided below with respect to FIGS. 5 and 6. In some examples, the segment processor 114 communicates with the neural network model 118 and/or the neural network model 128 to generate the music theory label identifications.

The post processor 116 is configured to improve training of the neural network model 118 by providing a comparative loss function between a ground truth of an input (e.g., audio tracks from source audio 130 with labeled segments and boundaries) and outputs of the boundary processor 112 (e.g., the segment boundary identifications) and the segment processor 114 (e.g., the music theory labels).

The neural network model 118 is trained using the audio processor 111 and configured to process an audio portion to provide segment boundary identifications and music theory labels within the audio portion. In some examples, the neural network model 118 includes one or more blocks of a spectral temporal transformer-in-transformer neural network model. The neural network model 128 is generally similar to the neural network model 118, but is stored remotely from the computing device 110 (e.g., at the data store 120).

Data store 120 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium. The data store 120 may store the neural network model 128 and/or source audio 130 (e.g., audio tracks for training the neural network models 118 and/or 128), for example. In some examples, the data store 120 provides the source audio 130 to the audio processor 111 for training the neural network model 118 and/or the neural network model 128. In some examples, one or more data stores 120 may be co-located (e.g., housed in one or more nearby buildings with associated components such as backup power supplies, redundant data communications, environmental controls, etc.) to form a datacenter, or may be arranged in other manners. Accordingly, in an embodiment, one or more of data stores 120 may be a datacenter in a distributed collection of datacenters.

Source audio 130 includes a plurality of audio tracks, such as songs, portions or excerpts from songs, etc. As used herein, an audio track may be a single song that contains several individual tracks, such as a guitar track, a drum track, a vocals track, etc., or may include only one track that is a single instrument or input, or a mixed track having multiple sub-tracks. Generally, the plurality of audio tracks within the source audio 130 are labeled with music theory labels for non-overlapping segments within the audio tracks. In some examples, different groups of audio tracks within the source audio 130 may be labeled with different music theory labels. For example, one group of audio tracks may use five labels (e.g., intro, verse, pre-chorus, chorus, outro), while another group uses seven labels (e.g., silence, intro, verse, refrain, bridge, instrumental, outro). Some groups may allow for segment sub-types (e.g., verse A, verse B) or compound labels (e.g., instrumental chorus).

In some examples, the audio processor 111 is configured to convert labels among audio tracks from the different groups to use a same plurality of music theory labels. This label conversion improves training opportunities by allowing for consistent training among different groups of audio tracks. Example groups of audio tracks within the source audio 130 may include SALAMI-pop, RWC-Pop, Harmonix, Isophonics, or other suitable groups, which may use different numbers of music theory labels, or different music theory labels for equivalent segments of an audio track. For example, one group may use “instrumental” while another group may use “solo”, and yet another group may differentiate between “guitar solo”, “bass solo”, and “piano solo”. The audio processor 111 may convert each of these labels to “instrumental” or another suitable label so that the audio tracks from the different groups may readily be used to train the neural network model 118.

Network 140 may comprise one or more networks such as local area networks (LANs), wide area networks (WANs), enterprise networks, the Internet, etc., and may include one or more of wired and/or wireless portions. Computing device 110 and data store 120 may include at least one wired or wireless network interface that enables communication with each other (or an intermediate device, such as a Web server or database server) via network 140. Examples of such a network interface include but are not limited to an IEEE 802.11 wireless LAN (WLAN) wireless interface, a Worldwide Interoperability for Microwave Access (Wi-MAX) interface, an Ethernet interface, a Universal Serial Bus (USB) interface, a cellular network interface, a Bluetooth™ interface, or a near field communication (NFC) interface. Examples of network 140 include a local area network (LAN), a wide area network (WAN), a personal area network (PAN), the Internet, and/or any combination thereof.

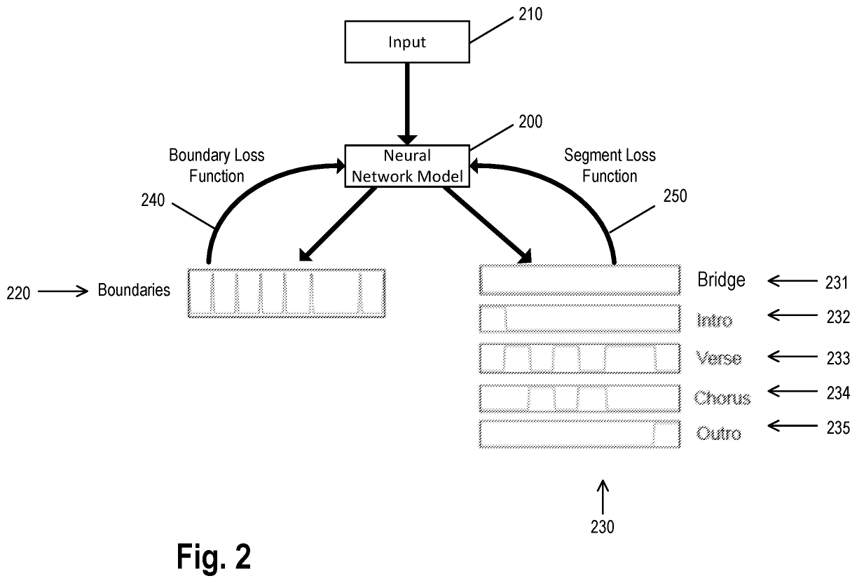

FIG. 2 shows a block diagram of an example of a neural network model 200 for providing segment boundary identifications 220 and music theory label identifications 230, according to an example embodiment. The neural network model 200 generally corresponds to the neural network model 118, in some examples. The neural network model 200 may receive an input 210, such as an audio portion from the source audio 130, and provide the segment boundary identifications 220 and the music theory label identifications 230. In the example shown in FIG. 2, the segment boundary identification 220 is provided as a probability level over the duration of the audio portion and the music theory label identifications 230 are provided as probability levels for each of five music theory labels: a bridge label 231, an intro label 232, a verse label 233, a chorus label 234, and an outro label 235. A vertical spike in the segment boundary identifications 220 corresponds to a likely start and/or end of a segment. As shown in FIG. 2, the neural network model 200 identifies seven segments, including a first segment as an intro, a second segment as a verse, a third segment as a chorus, a fourth segment as a verse, a fifth segment as a chorus, a sixth segment as a verse, and a seventh segment as an outro.

Using the generated segment boundary identifications 220 and music theory label identifications 230, the neural network model 200 is trained with one or more loss functions, such as a boundary loss function 240 and a segment loss function 250. In some examples, the segment loss function 250 is a first sum of a first weighted binary cross-entropy between the generated music theory label identifications 230 and corresponding music theory labels of the segments within the input 210 (e.g., ground-truth segment labels from the source audio 130). The segment loss function 250 may further include a connectionist temporal localization loss function configured to model a sequential order of music theory labels. In some scenarios, such as “pop” music, a music track follows one of several common progressions of music theory labels, such as verse, chorus, verse, chorus, etc. The connectionist temporal localization loss function improves responsiveness of the neural network model 200 to audio tracks that follow one of the common progressions of music theory labels, for example, by more heavily weighting a second music theory label (e.g., chorus) that follows a first music theory label (e.g., verse) when the sequence of the first label and the second label is commonly used in audio tracks.

In some examples, the boundary loss function 240 is a second sum of a second weighted binary cross-entropy between the segment boundary identifications and corresponding boundaries of the segments within the input 210.

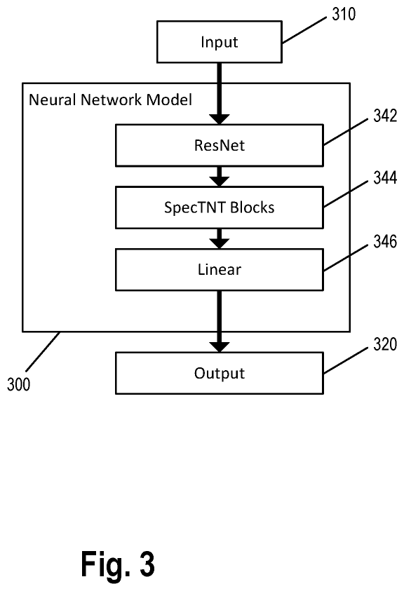

FIG. 3 shows a diagram of an example neural network model 300 for providing segment boundary identifications and music theory label identifications, according to an example embodiment. The neural network model 300 generally corresponds to the neural network model 118 and/or 200, in some examples, and receives an input 310 (e.g., similar to input 210) and provides an output 320 (e.g., similar to the segment boundary identifications 220 and music theory label identifications 230). In the example shown in FIG. 3, the neural network model 300 is implemented as a spectral temporal transformer-in-transformer (SpecTNT) neural network model. The features of a SpecTNT neural network model are based on interaction between two levels of transformer encoders, specifically a spectral transformer and a temporal transformer. The spectral transformer is configured to extract spectral features via Frequency Class Tokens (FCTs) for each time-step, where an FCT is an aggregated embedding that characterizes harmonic and timbral information. The temporal transformer then exchanges local information (i.e., FCTs) along the time axis. This self-attention step can help discover structural patterns related to novelty, homogeneity, and repetition. For example, the self-attention mechanism can allow frames around a boundary to attend to the boundary, and frames with the same function to attend to one another. Owing to its hierarchical design, SpecTNT permits a smaller number of parameters as compared to other neural network models.

The neural network model 300 is a SpecTNT model and comprises three modules: a two-dimensional residual network (ResNet) 342 at a front-end to extract intermediate information from an input 310; a stack of two or more SpecTNT blocks 344; and a linear layer 346 to provide an output 320 of target probabilities at various time-steps. In some examples, the input 310 is a raw audio portion directly from the source audio 130. In other examples, the audio processor 111 performs a Harmonic Constant-Q Transform (HCQT) on the raw audio portion to generate the input 310. In one example, the ResNet 342 includes convolutional layers that use a kernel size of 3, while five instances of the SpecTNT block 344 are applied, using 96 feature maps with 4 attention heads for the spectral encoder and 96 feature maps with 8 attention heads for the temporal encoder of each SpecTNT block 344.

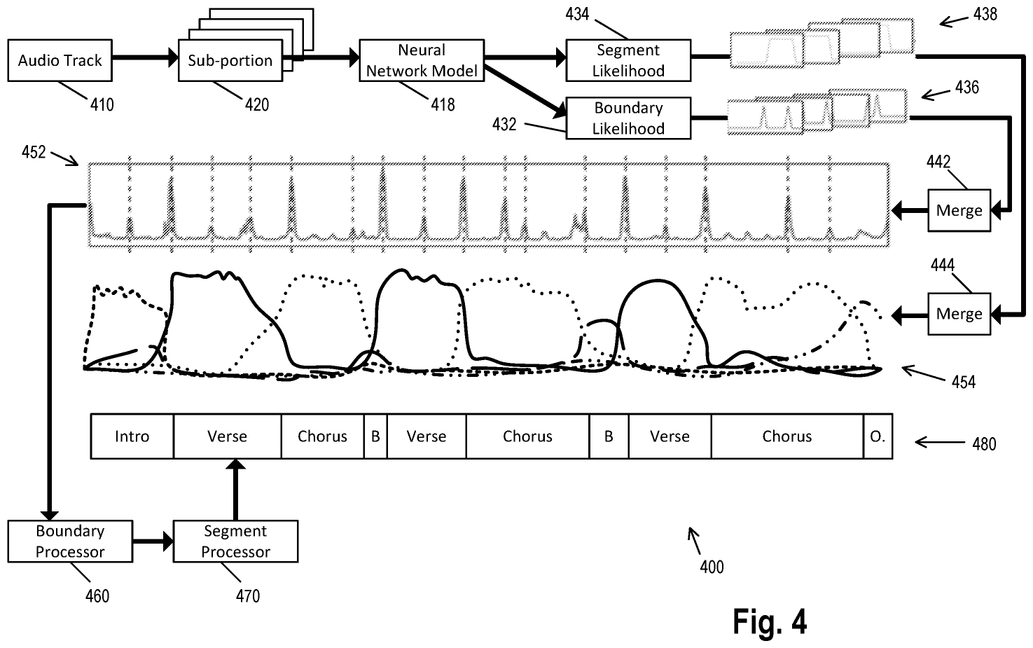

FIG. 4 shows a diagram of an example logic flow 400 for providing segment boundary identifications and music theory label identifications, according to an example embodiment. The logic flow 400 includes a neural network model 418 that generally corresponds to the neural network models 118, 128, 200, and/or 300. The neural network model 418 is configured to receive an audio track 410 and generate music theory label identifications and segment boundary identifications. In some examples, the audio processor 111 divides the audio track into a plurality of audio portions. In other words, the audio portions may be sub-portions 420 of a same audio track. For example, an audio track having a duration of 2 minutes (120 seconds) may be divided into 20 second portions, 24 second portions, 40 second portions, or another suitable duration.

In some examples, the portions 420 are non-overlapping so that the 120 second audio track is divided into six 20 second portions. In other examples, the portions 420 are overlapping, but offset by a predetermined duration, such as two seconds, three seconds, or another suitable duration. For example, the audio processor 111 may generate first audio portions using a sliding window across a first audio track. In other words, with a three second predetermined duration for overlap, the 120 second audio track is divided into approximately 40 portions: a first portion from 0 to 20 seconds; a second portion from 3 to 23 seconds; a third portion from 6 to 26 seconds, etc. Advantageously, dividing an audio track into shorter duration portions increases the number of samples available for training the neural network model 418 and improves accuracy of the neural network model 418. Additionally, training the neural network model 418 using shorter duration audio portions improves accuracy for analysis of short audio tracks (e.g., 20 or 25 second audio tracks). In some examples, an audio portion is “oversized” to accommodate an ending of an audio track. For example, with a three second predetermined duration for overlap, a 28 second audio track is divided into 3 portions: a first portion from 0 to 20 seconds; a second portion from 3 to 23 seconds; and a third portion from 6 to 28 seconds. In other examples, an audio portion is “undersized” to accommodate an ending of an audio track. For example, with a three second predetermined duration for overlap, a 28 second audio track is divided into 3 portions: a first portion from 0 to 20 seconds; a second portion from 3 to 23 seconds; a third portion from 6 to 26 seconds; and a fourth portion from 9 to 28 seconds.

The neural network model 418 generates a boundary likelihood 432 for each audio portion (e.g., the 20 second audio portion). The boundary likelihood 432 may be a boundary probability curve 438 that indicates a probability of a boundary across the audio portion. The neural network model 418 also generates a segment likelihood 434 for each audio portion. The segment likelihood 434 may be a plurality of label probability curves 436 that correspond to a plurality of music theory labels, for example, similar to the music theory label identifications 230. The audio processor 111 may also include a merge processor 442 for merging the boundary probability curves 438 from the audio portions of a single audio track into a single boundary probability curve 452 for the audio track. Similarly, the audio processor 111 may also include a merge processor 444 for merging the label probability curves 436 from the audio portions of a single audio track into label probability curves 454 for the audio track. The label probability curves are further described below with respect to FIG. 5.

The logic flow 400 includes a boundary processor 460, similar to the boundary processor 112, configured generate segment boundary identifications within audio portions. In the example shown in FIG. 4, the segment boundary identifications are shown as vertical dashed lines across the boundary probability curve 452. In some examples, the boundary processor 460 provides a segment boundary identification when the boundary probability curve 452 exceeds a predetermined threshold, such as 60% probability, 85% probability, etc.

The logic flow 400 also includes a segment processor 470, similar to the segment processor 114, configured to generate the music theory label identifications 480 for segments identified by the segment boundary identifications. In the example shown in FIG. 4, the music theory label identifications include ten labels: an intro, a verse, a chorus, a bridge (“B”), a verse, a chorus, a bridge, a verse, a chorus, and an outro. Notably, the segment processor 470 may identify music theory labels that cover more than one identified segment, for example, when a boundary identification has a relatively lower probability (e.g., 40%, 60%) than other identified boundaries (e.g., 85%). As one example, the first boundary identification has a relatively low probability as compared to the second boundary identification, so the segment processor 470 may consider the “intro” segment to include the first boundary identification. In the example shown in FIG. 4, the segment processor 470 identifies ten segments using the second, fifth, sixth, seventh, ninth, twelfth, thirteenth, fifteenth, and seventeenth boundary identifications.

FIG. 5 shows a diagram of an example plurality of label probability curves 500, according to an example embodiment. The plurality of label probability curves 500 generally correspond to the label probability curves 454 and, similar to the music theory label identifications 230, the plurality of label probability curves 500 include one probability curve for each of a plurality of music theory labels that may be generated by the neural network model 418. In the example shown in FIG. 5, the plurality of music theory labels includes an intro (probability curve 502), a verse (probability curve 504), a chorus (probability curve 506), a bridge (probability curve 508), and an outro (probability curve 510), with the combined probability curves shown at element 554 across a horizontal time scale (e.g., the duration of an audio portion or audio track).

FIG. 6 shows a diagram 600 of an example plurality of label probability curves, a boundary probability curve, and post-processed music theory label identifications, according to an example embodiment. For example, the diagram 600 includes the label probability curves 454, the boundary probability curve 452, the music theory label identifications 480, and post-processed music theory label identifications 610. The post-processed music theory label identifications 610 are generated by the post processor 116 based on the label probability curves 454, the boundary probability curve 452, and the music theory label identifications 480. Generally, the post processor 116 is configured to provide a comparative loss function between a ground truth of an audio track with labeled segments (not shown) and the curves 452 and 454. In other words, the post processor 116 compares the generated music theory label identifications 480 with the ground truth labels from the input audio track and provides increasing loss levels when the generated music theory label identifications 480 are further from the ground truth labels.

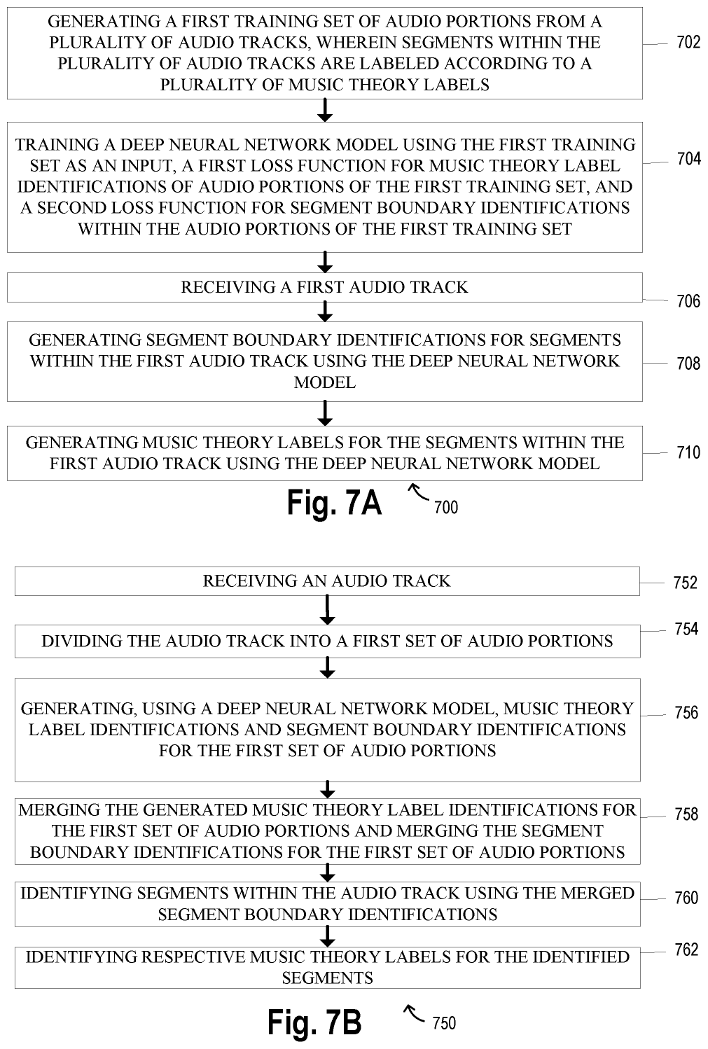

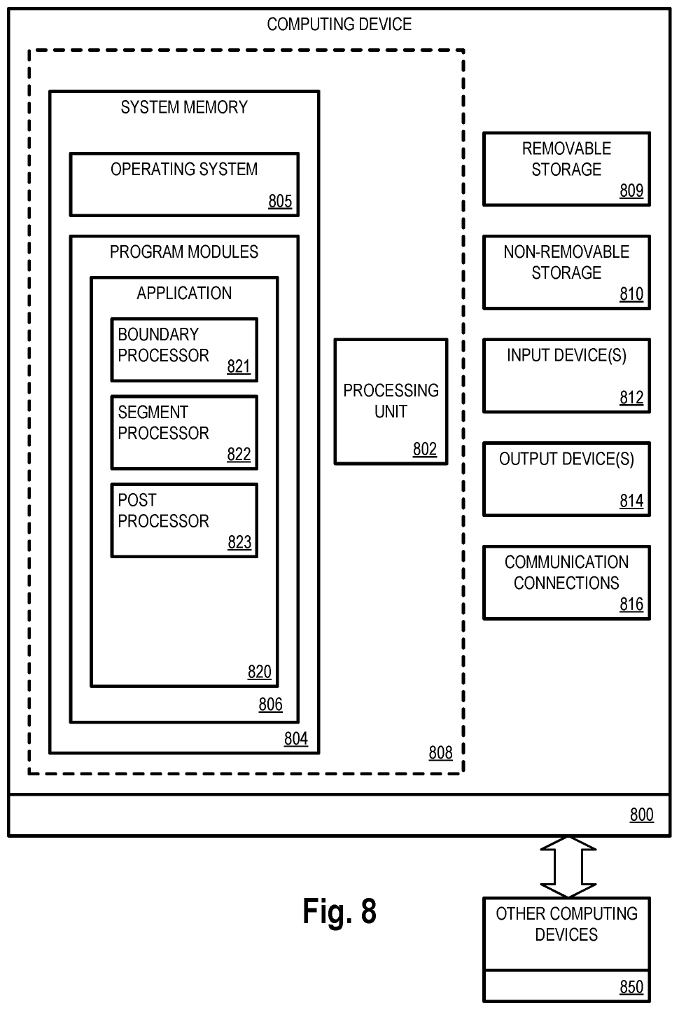

FIG. 7A shows a flowchart of an example method 700 for training a neural network model for identifying music theory labels for audio tracks, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 7A. Steps may be performed serially, in a partially overlapping manner, or fully in parallel. Thus, the order in which steps of method 700 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 7A may be performed by the computing device 110 (e.g., via the audio processor 111, the neural network model 118), or other suitable computing device. The steps of FIG. 7A may be performed using the neural network model 128, in some examples.

Method 700 begins with step 702. At step 702, a first training set of audio portions is generated from a plurality of audio tracks. Segments within the plurality of audio tracks are labeled according to a plurality of music theory labels. The plurality of audio tracks may be provided by the source audio 130, for example. In some examples, the audio portions of the first training set are generated using a sliding window across audio tracks from the source audio 130 and correspond to the sub-portions 420. The audio portions of the first training set have a same fixed duration (e.g., 20 seconds, 24 seconds, 30 seconds, etc.), in some examples. Moreover, in some examples, at least some audio portions of the first set of audio portions are sub-portions of a same audio track of the plurality of audio tracks (e.g., the audio portions are from a same song).

In some examples, segments within a same audio track of the plurality of audio tracks are non-overlapping with each other. In other words, one music structural element does not overlap with another.

At step 704, a deep neural network model is trained using the first training set as an input, a first loss function for music theory label identifications of audio portions of the first training set, and a second loss function for segment boundary identifications within the audio portions of the first training set. The music theory label identifications and segment boundary identifications are generated by the deep neural network model. In some examples, the deep neural network model corresponds to the neural network model 118, 128, 200, 300, 418. In some examples, the deep neural network model is a spectral temporal transformer-in-transformer (SpecTNT) neural network model.

In some examples, method 700 continues to include steps 706, 708, and 710.

At step 706, a first audio track is received. The first audio track may correspond to the audio track 410, in some examples.

At step 708, segment boundary identifications are generated for segments within the first audio track using the deep neural network model. The segment boundary identifications may be identified by the boundary processor 460 and/or the boundary processor 112, in various examples.

At step 710, music theory labels are generated for the segments within the first audio track using the deep neural network model. In some examples, the music theory labels correspond to the music theory label identifications 480.

In some examples, step 704 further includes generating a music theory label identification, selected from the plurality of music theory labels, for an audio portion of the first training set.

Step 704 may further include: generating the music theory label identifications for the first audio portions as a plurality of label probability curves that correspond to the plurality of music theory labels using the SpecTNT neural network model; generating the segment boundary identifications for the first audio portions as a boundary probability curve using the SpecTNT neural network model; and merging the generated music theory label identifications and the segment boundary identifications for the first audio portions. For example, the neural network model 418 may generate the segment likelihood 434 and the boundary likelihood 432 that are merged by the merge processors 442 and 444.

In some examples, step 704 may further include selecting a single generated music theory label identification for a segment identified by two adjacent segment boundary identifications according to average probabilities of the generated music theory label identifications during the segment. For example, a segment between two adjacent segment boundary identifications may begin with an 80% chance of being a chorus, transition to a 60% chance of being a chorus, then increase to a 95% chance of being a chorus, while also having a constant 70% chance of being a bridge. In this example, the average of the chorus probability is 78%, so the chorus label may be selected as having a higher average probability than the bridge label. In some examples, the two adjacent segment boundary identifications may be adjusted using ground-truth boundaries of the segment.

In some examples, the first loss function is a first sum of a first weighted binary cross-entropy between the generated music theory label identifications and corresponding music theory labels of the segments, and the second loss function is a second sum of a second weighted binary cross-entropy between the segment boundary identifications and corresponding boundaries of the segments.

In some examples, the first loss function further includes a connectionist temporal localization loss configured to model a sequential order of music theory labels.

FIG. 7B shows a flowchart of an example method 750 for identifying music theory labels for an audio track, according to an example embodiment. Technical processes shown in these figures will be performed automatically unless otherwise indicated. In any given embodiment, some steps of a process may be repeated, perhaps with different parameters or data to operate on. Steps in an embodiment may also be performed in a different order than the top-to-bottom order that is laid out in FIG. 7B. Steps may be performed serially, in a partially overlapping manner, or fully in parallel. Thus, the order in which steps of method 750 are performed may vary from one performance to the process of another performance of the process. Steps may also be omitted, combined, renamed, regrouped, be performed on one or more machines, or otherwise depart from the illustrated flow, provided that the process performed is operable and conforms to at least one claim. The steps of FIG. 7B may be performed by the computing device 110 (e.g., via the audio processor 111, the neural network model 118), or other suitable computing device. The steps of FIG. 7B may be performed using the neural network model 128, in some examples.

Method 750 begins with step 752. At step 752, an audio track is received. The audio track may correspond to the audio track 410, in some examples.

At step 754, the audio track is divided into a first set of audio portions. In some examples, dividing the audio track includes generating first audio portions using a sliding window across the audio track. In some examples, the first audio portions have a same fixed duration. The first set of audio portions may correspond to audio portions 420, in some examples.

At step 756, music theory label identifications and segment boundary identifications are generated for the first set of audio portions using a spectral temporal transformer-in-transformer (SpecTNT) neural network model. The SpecTNT model corresponds to the neural network model 118, 128, 300, and/or 418, in various examples. The music theory label identifications and the segment boundary identifications may correspond to the music theory label identifications 438 and the segment boundary identifications 436, in some examples.

At step 758, the generated music theory label identifications for the first set of audio portions are merged and the segment boundary identifications for the first set of audio portions are merged (e.g., by the merge processor 442 and the merge processor 444).

At step 760, segments within the audio track are identified using the merged segment boundary identifications. The segments may be identified by the boundary processor 460 and/or the boundary processor 112, in various examples.

At step 762, respective music theory labels are identified for the identified segments. The segment processor 114 may perform step 762. In some examples, identifying the music theory labels comprises selecting the music theory labels from a plurality of music theory labels. In some examples, identifying the respective music theory labels comprises selecting a single music theory label for a segment according to average probabilities of the generated music theory label identifications during the segment. In some examples, the plurality of music labels generally corresponds to the music theory label identifications 230.

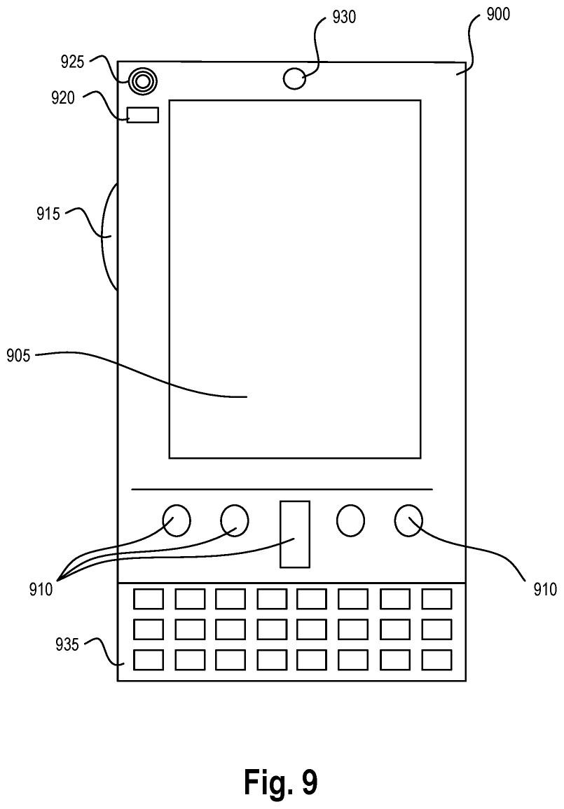

FIGS. 8, 9, and 10 and the associated descriptions provide a discussion of a variety of operating environments in which aspects of the disclosure may be practiced. However, the devices and systems illustrated and discussed with respect to FIGS. 8, 9, and 10 are for purposes of example and illustration and are not limiting of a vast number of computing device configurations that may be utilized for practicing aspects of the disclosure, as described herein.

FIG. 8 is a block diagram illustrating physical components (e.g., hardware) of a computing device 800 with which aspects of the disclosure may be practiced. The computing device components described below may have computer executable instructions for implementing a music theory label generation application 820 on a computing device (e.g., computing device 110), including computer executable instructions for music theory label generation application 820 that can be executed to implement the methods disclosed herein. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for running music theory label generation application 820, such as one or more components with regard to FIGS. 1, 2, 3, and 4, in particular, boundary processor 821 (e.g., corresponding to boundary processor 112), segment processor 822 (e.g., corresponding to segment processor 114), and post processor 823 (e.g., corresponding to post processor 116).

The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., music theory label generation application 820) may perform processes including, but not limited to, the aspects, as described herein. Other program modules that may be used in accordance with aspects of the present disclosure, and in particular for generating music theory labels, may include boundary processor 821, segment processor 822, and post processor 823.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

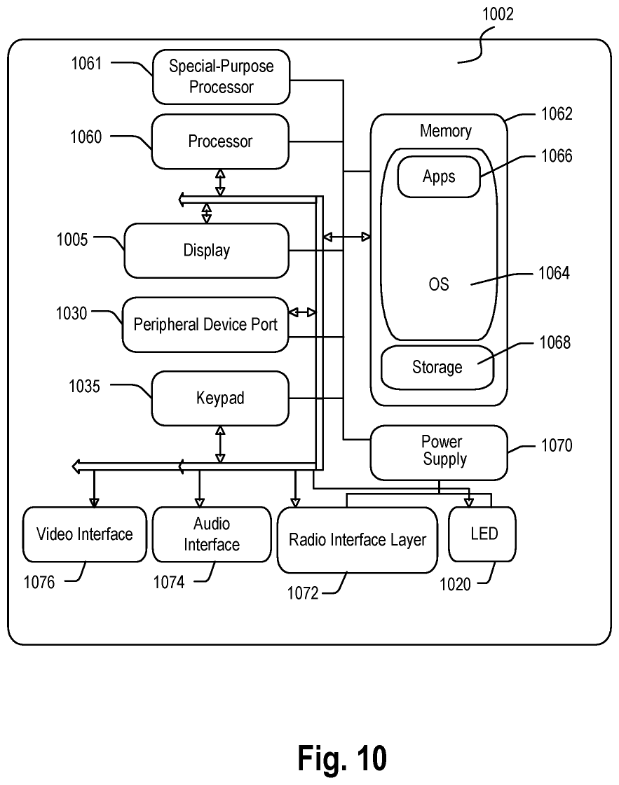

FIGS. 9 and 10 illustrate a mobile computing device 900, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 900 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as email or other messages used by an email application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer.

The system 1002 has a power supply 1070, which may be implemented as one or more batteries. The power supply 1070 may further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via an audio transducer 925 (e.g., audio transducer 925 illustrated in FIG. 9). In the illustrated embodiment, the visual indicator 1020 is a light emitting diode (LED) and the audio transducer 925 may be a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of peripheral device 1030 (e.g., on-board camera) to record still images, video stream, and the like.

A mobile computing device 900 implementing the system 1002 may have additional features or functionality. For example, the mobile computing device 900 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 900 and stored via the system 1002 may be stored locally on the mobile computing device 900, as described above, or the data may be stored on any number of storage media that may be accessed by the device via the radio interface layer 1072 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 1072 or via a distributed computing network. Similarly, such data/information may be readily transferred between computing devices for storage and use according to well-known data/information transfer and storage means, including electronic mail and collaborative data/information sharing systems.

As should be appreciated, FIGS. 9 and 10 are described for purposes of illustrating the present methods and systems and is not intended to limit the disclosure to a particular sequence of steps or a particular combination of hardware or software components.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A computer-implemented method of training a neural network model for identifying music theory labels for audio tracks, the method comprising:
generating a first training set of audio portions from a plurality of audio tracks, wherein segments within the plurality of audio tracks are labeled according to a plurality of music theory labels;
training a deep neural network model using the first training set as an input, a first loss function for music theory label identifications of audio portions of the first training set, and a second loss function for segment boundary identifications within the audio portions of the first training set, wherein the music theory label identifications and the segment boundary identifications are generated by the deep neural network model;
receiving a first audio track;
generating segment boundary identifications for segments within the first audio track using the deep neural network model; and
generating music theory labels for the segments within the first audio track using the deep neural network model.

2. The method of claim 1, wherein training the deep neural network model includes generating a music theory label identification, selected from the plurality of music theory labels, for an audio portion of the first training set.

3. The method of claim 1, wherein audio portions of the first training set have a same fixed duration.

4. The method of claim 3, wherein at least some audio portions of the first set of audio portions are sub-portions of a same audio track of the plurality of audio tracks.

5. The method of claim 1, wherein segments within a same audio track of the plurality of audio tracks are non-overlapping with each other.

6. The method of claim 5, wherein generating the first training set comprises generating first audio portions using a sliding window across the same audio track.

7. The method of claim 6, wherein the deep neural network is a spectral temporal transformer-in-transformer (SpecTNT) neural network and training the deep neural network model comprises:
generating the music theory label identifications for the first audio portions as a plurality of label probability curves that correspond to the plurality of music theory labels using the SpecTNT neural network model;
generating the segment boundary identifications for the first audio portions as a boundary probability curve using the SpecTNT neural network model; and
merging the generated music theory label identifications and the segment boundary identifications for the first audio portions.

8. The method of claim 7, wherein the method further comprises selecting a single generated music theory label identification for a segment identified by two adjacent segment boundary identifications according to average probabilities of the generated music theory label identifications during the segment.

9. The method of claim 8, wherein selecting the single generated music theory label identification comprises adjusting the two adjacent segment boundary identifications using ground-truth boundaries of the segment.

10. The method of claim 1, wherein the first loss function is a first sum of a first weighted binary cross-entropy between the generated music theory label identifications and corresponding music theory labels of the segments;
wherein the second loss function is a second sum of a second weighted binary cross-entropy between the segment boundary identifications and corresponding boundaries of the segments.

11. The method of claim 1, wherein the first loss function further includes a connectionist temporal localization loss configured to model a sequential order of music theory labels.

12. A method for identifying music theory labels for an audio track, the method comprising:
receiving an audio track;
dividing the audio track into a first set of audio portions;
generating, using a deep neural network model, music theory label identifications and segment boundary identifications for the first set of audio portions;
merging the generated music theory label identifications for the first set of audio portions and merging the segment boundary identifications for the first set of audio portions;
identifying segments within the audio track using the merged segment boundary identifications;
identifying respective music theory labels for the identified segments.

13. The method of claim 12, wherein identifying the music theory labels comprises selecting the music theory labels from a plurality of music theory labels.

14. The method of claim 12, wherein dividing the audio track into the first set of audio portions comprises generating first audio portions using a sliding window across the audio track.

15. The method of claim 14, wherein the first audio portions have a same fixed duration.

16. The method of claim 12, wherein identifying the respective music theory labels for the identified segments comprises selecting a single music theory label for a segment according to average probabilities of the generated music theory label identifications during the segment.

17. A non-transient computer-readable storage medium comprising instructions being executable by one or more processors, that when executed by the one or more processors, cause the one or more processors to:
generate a first training set of audio portions from a plurality of audio tracks, wherein segments within the plurality of audio tracks are labeled according to a plurality of music theory labels; and
train a deep neural network model using the first training set as an input, a first loss function for music theory label identifications of audio portions of the first training set, and a second loss function for segment boundary identifications within the audio portions of the first training set, wherein the music theory label identifications and the segment boundary identifications are generated by the deep neural network model;
receive a first audio track;
generate segment boundary identifications for segments within the first audio track using the deep neural network model; and
generate music theory labels for the segments within the first audio track using the deep neural network model.

18. The computer-readable storage medium of claim 17, wherein the instructions are executable by the one or more processors to cause the one or more processors to:
generate a music theory label identification, selected from the plurality of music theory labels, for an audio portion of the first training set.

19. The computer-readable storage medium of claim 17, wherein segments within a first audio track of the plurality of audio tracks are non-overlapping with each other;
wherein the instructions are executable by the one or more processors to cause the one or more processors to generate first audio portions using a sliding window across the first audio track.

20. The computer-readable storage medium of claim 17, wherein the instructions are executable by the one or more processors to cause the one or more processors to:
generate the music theory label identifications for the first audio portions as a plurality of label probability curves that correspond to the plurality of music theory labels using the deep neural network model;
generate the segment boundary identifications for the first audio portions as a boundary probability curve using the deep neural network model; and
merge the generated music theory label identifications and the segment boundary identifications for the first audio portions.
